(19) United States
(12) Patent Application Publication
(10) Pub. No.: US 2016/0098212 A1
(43) Pub. Date: Apr. 7, 2016

(54) INFORMATION PROCESSOR APPARATUS, MEMORY CONTROL DEVICE, AND CONTROL METHOD

(71) Applicant: FUJITSU LIMITED, Kawasaki-shi (JP)

(72) Inventors: AKIO TOKOYODA, FUCHU (JP); Koji HOSOE, Yamato (JP); Masatoshi Aihara, Hiratsuka (JP); Yuta Toyoda, Kawasaki (JP); Makoto SUGA, Edogawa (JP)

(21) Appl. No.: 14/847,360

(22) Filed: Sep. 8, 2015

(30) Foreign Application Priority Data
Oct. 7, 2014 (JP) 2014-206423

(51) Int. Cl. G06F 3/06

(52) U.S. Cl. CPC G06F 3/0611; G06F 3/0635; G06F 3/0673

(57) ABSTRACT

An information processor apparatus includes: a storage device to perform processing based on a read request or a write request and output a response after completing the processing; an arithmetic processor to output the read and write requests to the storage device; and a control device, including paths, to control the storage device; the control device: receives the read request or the write request from the arithmetic processor; acquires, for each of the paths, an overall time until the response to a transmitted read and write requests is received based on a first number of the transmitted read requests and a second number of the transmitted write requests, selects a used path based on the overall time; transmits the read request or the write request through the used path to the storage device; and receives the response to the read request or the write request through the used path.

### CROSS-REFERENCE TO RELATED APPLICATION

This application is based upon and claims the benefit of priority of the prior Japanese Patent Application No. 2014-206423, filed on Oct. 7, 2014, the entire contents of which are incorporated herein by reference.

### FIELD

The embodiment discussed herein relates to an information processor apparatus, a memory control device, and a control method.

### BACKGROUND

The fragmentation of the manufacturing process for processors mounted in an information processor apparatus such as a high-performance computer (HPC), a server, a personal computer (PC), or a mobile telephone, has advanced and the calculating speeds per processor has improved. As a result of the increased calculating speeds of such processors, increases in the capacity and the bandwidth of primary storage devices are desired.

Related techniques are disclosed in Japanese Laid-Open Patent Publication No. 2012-74042 and Japanese Laid-Open Patent Publication No. 07-253923.

### SUMMARY

According to an aspect of the embodiments, an information processor apparatus includes: a storage device configured to perform processing in response to a read request or a write request and output a response after completing the processing; an arithmetic processor configured to output the read request and the write request to the storage device; and a control device, including paths coupled to the storage device, configured to control the storage device; wherein, the control device: receives the read request or the write request from the arithmetic processor; acquires, for each of the paths, an overall time until the response to a transmitted read request and a transmitted write request is received based on a first number of the transmitted read requests and a second number of the transmitted write requests, the transmitted read request and the transmitted write request having been transmitted to the paths, responses for the transmitted read request and the transmitted write request having not been received, selects a used path to be used based on the overall time; transmits the read request or the write request through the used path to the storage device; and receives, from the storage device, the response to the read request or the write request through the used path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an information processor apparatus;

FIG. 2 illustrates an example of a HMC;

FIG. 3 illustrates an example of command issue processing of an information processor apparatus;

FIG. 4 illustrates an example of an information processor apparatus; and

FIG. 5 illustrates an example of guarantee processing for a processing order of requests in an information processor apparatus.

### DESCRIPTION OF EMBODIMENTS

In order to handle improved performance of memories, memory elements in which a dynamic random access memory (DRAM) control element such as a hybrid memory cube (HMC) is embedded are used in place of, for example, a dual inline memory module (DIMM).

Mounting density is improved in the HMC due to the stratification of the DRAM and a larger capacity is realized. A plurality of memory controllers are built into the HMC and wide bands may be realized by using a high-speed serial connections for the interfaces between the central processing unit (CPU) and the memories.

The HMC has a plurality of interfaces for coupling with the CPU. The total bandwidth increases in relation to the number of coupled interfaces. When all of the interfaces are used, the memories mounted in the HMC exhibit maximum performance.

A memory controller for controlling address spaces is assigned in accordance with the addresses of the memories in the HMC. The plurality of interfaces in the HMC are each coupled to the memory controller through a switch. The interfaces have differences in latency in response to the paths coupled through the switch. Directly-controlled interfaces having smaller latencies between the memory controller managing the memories may be assigned to each memory. The latency may be reduced by using the directly-controlled interfaces when accessing the memories. As a result, the interfaces to be accessed are sorted based on the addresses to be accessed.

In a multiport memory for example, the order of processing for processing requests received at each port is determined in response to quality of service (QoS) parameters related to the processing requests. Moreover, a queue for storing processing requests to the memory therein and a shunt for avoiding the queue are provided, and when a processing request is sent directly to the memory, the processing request is transmitted to the memory using the shunt.

Accesses may be concentrated on specific interfaces when sorting the processing requests using addresses based on latency. In this case, the access to other interfaces is reduced and the total bandwidth of the memories may drop. As a result, memory performance may not be used effectively when sorting the processing requests in accordance with latency.

Even if the processing order of the processing requests is changed in response to the QoS parameters of the processing requests, or even if a shunt for avoiding the queue is provided, the access to the interfaces may not by equalized.

The information processor apparatus, the memory control device, and the control method for the information processor apparatus disclosed herein are not limited by the following embodiment.

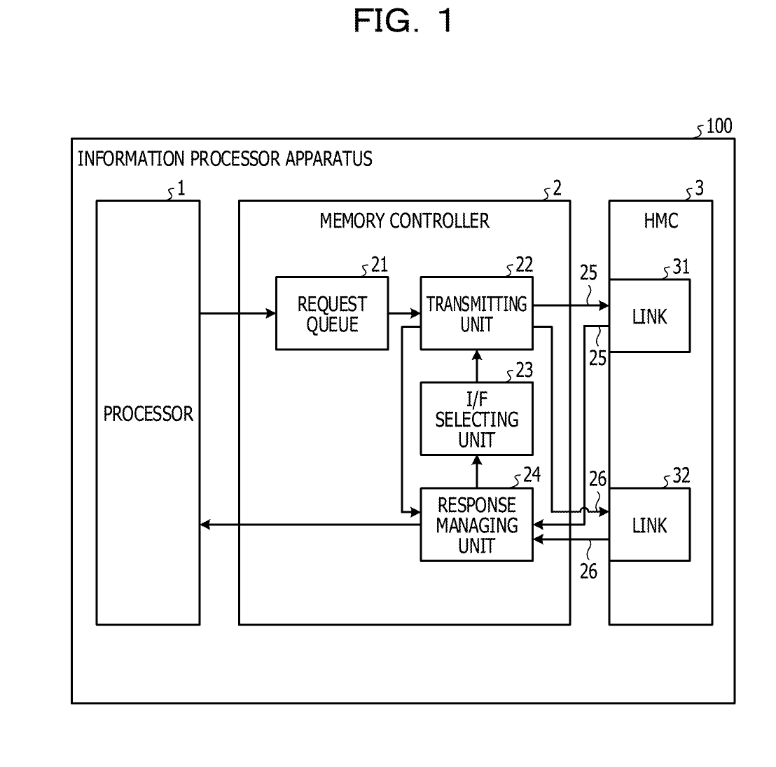

FIG. 1 illustrates an example of an information processor apparatus. An information processor apparatus 100 has a processor 1, a memory controller 2, and a HMC 3.

The processor 1 outputs a read request of data from the HMC 3 to the memory controller 2. Next, the processor 1 receives a read response that is a response to the outputted read request from the memory controller 2.

The processor 1 outputs a write request of data to the HMC 3 to the memory controller 2. Next, the processor 1 receives a write response that is a response to the outputted write request from the memory controller 2. The write request and the read request may be collectively referred to as “requests” hereinbelow. The processor 1 may be an example of an “arithmetic processor”.

The memory controller 2 has a request queue 21, a transmitting unit 22, an interface (I/F) selecting unit 23, a response managing unit 24, and I/Fs 25 and 26. The number of I/Fs may be two but the memory controller 2 may also be provided with three or more I/Fs. For example, the memory controller 2 may have four or eight I/Fs. The memory controller 2 may be an example of a “memory control device”. The I/Fs 25 and 26 may be an example of a “plurality of output paths”.

The request queue 21 receives requests from the processor 1. The request queue 21 accumulates received requests therein so that older requests are in front.

The request queue 21 transmits the front request among the requests stored in the queue to the transmitting unit 22. The request queue 21 may be an example of a “receiving unit”.

The transmitting unit 22 obtains requests from the request queue 21. The transmitting unit 22 transmits the type of request about whether the obtained request is a read request or a write request to the I/F selecting unit 23. The transmitting unit 22 receives information of the I/F selected by the I/F selecting unit 23. For example, the I/F 25 may be selected by the I/F selecting unit 23.

The transmitting unit 22 outputs the address indicated in the request to the I/F selecting unit 23 upon receiving an obtaining request to obtain the address indicated in the request from the I/F selecting unit 23.

The transmitting unit 22 transmits the obtained requests to the HMC 3 through the I/F 25 selected by the I/F selecting unit 23. The transmitting unit 22 transmits identification information of the transmitted requests to the response managing unit 24. The identification information of the requests may be, for example, tags of the requests to be transmitted by the transmitting unit 22.

The I/F selecting unit 23 receives information about the type of request from the transmitting unit 22. Next, the I/F selecting unit 23 receives a read response waiting number and a write response waiting number in the respective I/Fs 25 and 26 from the response managing unit 24.

The write response is a response from the HMC 3 with respect to a write command corresponding to the write request issued by the transmitting unit 22 to the HMC 3. The write response waiting number is the number of the write requests in a state in which the write response corresponding to the write command issued by the transmitting unit 22 to the HMC 3 has not been received by the response managing unit 24. A write response that has been issued may correspond to an example of a “transmitted write request”.

The read response is a response from the HMC 3 with respect to a read command corresponding to the read request issued by the transmitting unit 22 to the HMC 3. The read response waiting number is the number of the read requests in a state in which the read response corresponding to the read command issued by the transmitting unit 22 to the HMC 3 has not been received by the response managing unit 24. A read response that has been issued may correspond to an example of a “transmitted read request”.

The I/F selecting unit 23 stores the number of cycles used for obtaining the write response and number of cycles used for obtaining the read response.

The number of cycles used to issue the write request is the sum of the number of cycles for outputting a command and the number of cycles for outputting the data. For example, the number of cycles used to issue the write request may be nine cycles when one cycle for the command and eight cycles for the data are added together.

The number of cycles for obtaining the write response may be only the number of cycles for receiving the command. The response managing unit 24 takes one cycle to receive one packet. A command is one packet. As a result, one cycle is the number of cycles for obtaining the write response.

The number of cycles for obtaining a read response is the sum of the number of cycles for receiving the command and the number of cycles for receiving the data. The number of packets sent during one read response may be predetermined according to the information processor apparatus 100. For example, the number of packets sent during one read response may be eight packets. In this case, the number of cycles for obtaining the read response is nine cycles when one cycle for the command and eight cycles for the data are added together.

The I/F selecting unit 23 obtains an issuance state of the write command from each of the I/Fs 25 and 26 from the transmitting unit 22. The I/F selecting unit 23 waits one cycle and once again obtains the issuance states of the command for the I/Fs 25 and 26 while both of the I/Fs 25 and 26 are issuing a write command.

If a write command is not being issued from either one of the I/F 25 or 26, the I/F selecting unit 23 selects the I/F that is not issuing a write command as the I/F for sending the command. The I/F that is not issuing a write command may be an example of an “unused path”. The I/F that transmits a command may be an example of a “used output path”.

When a write command is not being issued by either of the I/Fs 25 and 26, the I/F selecting unit 23 carries out a process to select an I/F for transmitting commands. For example, the I/F selecting unit 23 multiplies the waiting number for the read responses of each of the I/Fs 25 and 26 received from the response managing unit 24 by the number of cycles for obtaining the read response to calculate the number of cycles for obtaining all of the read responses. The I/F selecting unit 23 multiplies the waiting number for the write responses of each of the I/Fs 25 and 26 received from the response managing unit 24 by the number of cycles for obtaining the write response to calculate the number of cycles for obtaining all of the write responses.

The I/F selecting unit 23 adds up the number of cycles for obtaining all of the read responses and the number of cycles for obtaining all of the write responses of the I/F 25 to derive the total number of cycles for obtaining all the responses to the requests of the I/F 25. The I/F selecting unit 23 adds up the number of cycles for obtaining all of the read responses and the number of cycles for obtaining all of the write responses of the I/F 26 to derive the total number of cycles for obtaining all the responses to the requests of the I/F 26.

If the total number of number of cycles for obtaining all of the responses to the requests of the I/F 25 and the total number of number of cycles for obtaining all of the responses to the requests of the I/F 26 are the same, the I/F selecting unit 23 obtains an address specified by a request from the transmitting unit 22. The I/F selecting unit 23 previously stores whether a directly-controlled interface for each memory is the I/F 25 or I/F 26. The I/F with the smallest latency for writing to each memory is assigned as the directly-controlled I/F. The I/F selecting unit 23 specifies the directly-controlled interface for the memory having an address obtained from among the I/F 25 or I/F 26 and selects the specified I/F as the I/F for transmitting the commands.

The I/F selecting unit 23 may select the I/F having the smallest total number of cycles for obtaining all the responses to the requests as the I/F for transmitting commands among the I/F 25 and the I/F 26 when the request received from the transmitting unit is a write request.

The I/F selecting unit 23 may select the I/F having the largest total number of cycles for obtaining all the responses to the requests as the I/F for transmitting commands among the I/F 25 and the I/F 26 when the request received from the transmitting unit is a read request. The I/F selecting unit 23 may be an example of a “selecting unit”.

The number of cycles used to transmit the write request is the sum of the number of cycles for transmitting a command and the number of cycles for transmitting the data. The transmitting unit 22 takes one cycle to send one packet. The number of packets transmitted during one write request is the same as the number of packets sent during one read response. As a result, the number of cycles for obtaining the read response is nine cycles when one cycle for the command and eight cycles for the data are added together.

The number of cycles used to transmit a read request is merely the number of cycles for transmitting a command. For example, the number of cycles for transmitting a read request is one cycle.

The transmission of a write request takes a longer period of time than the transmission of a read request. As a result, the write request is sent to the I/F taking the longer period of time to complete the processing of previously transmitted requests, and the read request is sent to the I/F taking the shorter period of time to complete the processing of previously transmitted requests. As a result, the utilization rates of the I/F 25 and the I/F 26 may be equalized.

The response managing unit 24 receives the write responses or the read responses transmitted from the HMC 3 through the I/F 25 or the I/F 26. The I/F used by the response managing unit 24 to obtain the responses may correspond to the I/F used by the transmitting unit 22 for transmitting the commands that are the origins of the responses.

The response managing unit 24 receives the identification information of the transmitted request from the transmitting unit 22. The response managing unit 24 uses the received information of the response to derive a waiting number of the write response and a waiting number of the read response. The response managing unit 24 transmits the waiting number of the write response and the waiting number of the read response to the I/F selecting unit 23. The response managing unit 24 may be an example of a “response receiving unit”.

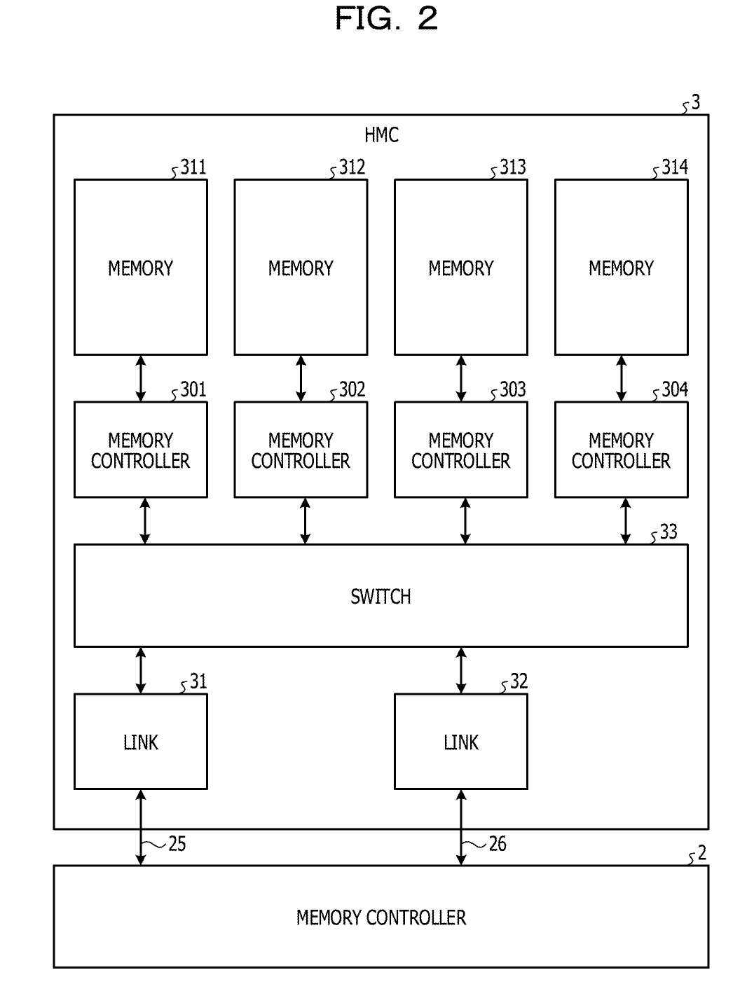

The HMC 3 has links 31, 32, a switch 33, memory controllers 301 to 304, and memories 311 to 314 as illustrated in FIG. 2. The HMC 3 may be an example of a “storage device”. FIG. 2 illustrates an example of a HMC.

The memories 311 to 314 may be DRAMs for example. The memories 311 to 314 are assigned different addresses, respectively. The memories 311 to 314 may be referred to below as a “memory 310” when no distinction is made between the memories.

The memory controllers 301 to 304 are connected to the respective memories 311 to 314 and manage the memory connected thereto. The memory controllers 301 to 304 may be referred to below as a “memory controller 300” when no distinction is made between the memory controllers. The memory controller 300 receives write requests and read requests and reads and writes the data on the managed memory 310.

In the case of a write request, the memory controller 300 transmits a response for notifying the completion of processing to the link 31 or link 32 that is the transmission source of the command when the writing onto the managed memory 310 is completed. In the case of a read request, the memory controller 300 transmits a response for transmitting the read data to the link 31 or link 32 that is the transmission source of the command when the writing onto the managed memory 310 is completed.

The switch 33 switches the connection paths between the links 31 and 32 and the memory controllers 300. When, for example, a command is input to the link 31, the switch 33 switches the connection so that the link 31 is coupled to the memory controller 300 coupled to the memory 310 having the address indicated in the command.

The link 31 is an interface of the HMC 3 for coupling with the I/F 25. The link 32 is an interface of the HMC 3 for coupling with the I/F 26. For example, the link 31 receives a command sent from the transmitting unit 22 through the I/F 25 or the I/F 26. The switch 33 is switched so that the link 31 is coupled to the memory controller 300 managing the memory 310 having the address indicated in the command. The link 31 transmits the received command through the switch 33 to the memory controller 300.

Next, the link 31 receives the response corresponding to the transmitted command from the memory controller 300. For example, in the case of a write request, the link 31 receives a response notifying the completion of the processing. In the case of a read request, the link 31 receives the data read from the memory 310 according to the read command. The link 31 transmits the received response to the memory controller 2.

There is a difference in the distances of the connection paths between the links 31 and 32 and the respective memory controllers 300. Latency may be smaller in correspondence with a smaller communication distance. For example, the links 31 and 32 each have a memory controller 300 with the smallest latency. Because the memory controllers 300 have a one-on-one correspondence with the memories 310, each memory 310 has a link with the smallest latency among the links 31 and 32. The link 31 corresponds to the I/F 25 and the link 32 corresponds to the I/F 26. For example, each memory 310 has an I/F with the smallest latency. As a result, the I/F with the smallest latency may be assigned as the directly-controlled I/F to each memory 310. For example, the I/F 25 may be assigned as the directly-controlled I/F to the memory 311 and the memory 312. For example, the I/F 26 may be assigned as the directly-controlled I/F to the memory 313 and the memory 314.

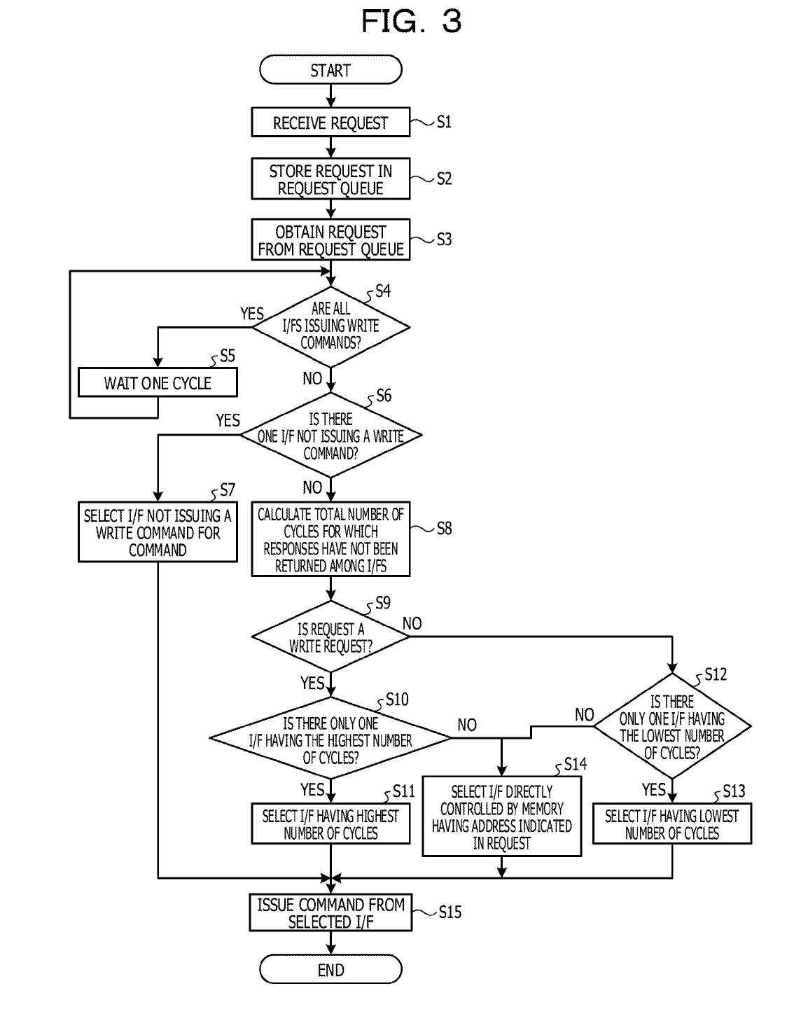

FIG. 3 illustrates an example of command issue processing of an information processor apparatus. The command issue processing illustrated in FIG. 3 may be performed by the information processor apparatus illustrated in FIG. 1. The I/Fs 25 and 26 are referred to collectively as an “I/F 20” when no distinction is made among the I/Fs.

The request queue 21 receives a request output from the processor 1 (operation S1).

The received request is stored in the request queue 21 (operation S2).

The transmitting unit 22 obtains the request from the front of the request queue 21 (operation S3). The transmitting unit 22 transmits the type of the obtained request to the I/F selecting unit 23.

The I/F selecting unit 23 determines if both of the I/Fs 25 and 26 are issuing write commands (operation S4). If both of the I/Fs 25 and 26 are issuing write commands (operation S4: Yes), the I/F selecting unit 23 waits one cycle (operation S5) and the routine returns to operation S4.

If any one of the I/Fs 25 and 26 is not issuing a write command (operation S4: No), the I/F selecting unit 23 determines whether there is only one I/F 20 not issuing a write command (operation S6). If only one of the I/Fs 20 is not issuing a write command (operation S6: Yes), the I/F selecting unit 23 selects the I/F 20 that is not issuing a write command as the I/F for transmitting the command (operation S7). Next, the processing advances to operation S15.

If there are more than one I/Fs 20 not issuing a write command (operation S6: No), the I/F selecting unit 23 obtains the read response waiting number and the write response waiting number for each of the I/Fs 20 from the response managing unit 24. The I/F selecting unit 23 calculates the total of the number of cycles of responses not returned for each I/F 20 (operation S8).

The I/F selecting unit 23 determines whether the request received by the transmitting unit 22 is a write request (operation S9). If the request is a write request (operation S9: Yes), the I/F selecting unit 23 determines whether there is only one I/F 20 with the highest total number of cycles of responses not returned (operation S10).

If the number of I/Fs 20 with the highest total number of cycles of responses not returned is one (operation S10: Yes), the I/F selecting unit 23 selects the I/F 20 with the highest total number of cycles of responses not returned as the I/F for transmitting the command (operation S11).

If there are more than one I/Fs 20 with the highest total number of cycles of responses not returned (operation S10: No), the I/F selecting unit 23 extracts the directly-controlled interface I/F 20 for the memory 310 having the address designated in the request. The I/F selecting unit 23 selects the extracted I/F 20 as the I/F for transmitting the command (operation S14).

If the request is a read request (operation S9: No), the I/F selecting unit 23 determines whether there is only one I/F 20 with the lowest total number of cycles of responses not returned (operation S12).

If the number of I/Fs 20 with the lowest total number of cycles of responses not returned is one (operation S12: Yes), the I/F selecting unit 23 selects the I/F 20 with the lowest total number of cycles of responses not returned as the I/F for transmitting the command (operation S13).

If there are more than one I/Fs 20 with the lowest total number of cycles of responses not returned (operation S12: No), the I/F selecting unit 23 extracts the directly-controlled interface I/F 20 for the memory 310 having the address designated in the request. The I/F selecting unit 23 selects the extracted I/F 20 as the I/F for transmitting the command (operation S14).

The transmitting unit 22 issues the command using the I/F 20 selected by the I/F selecting unit 23 to the HMC 3 (operation S15).

The information processor apparatus determines the I/F for issuing the command based on the total number of cycles of responses not returned by the I/Fs. As a result the utilization amounts among the I/Fs are equalized and the highest performance of the memory bandwidth may be realized.

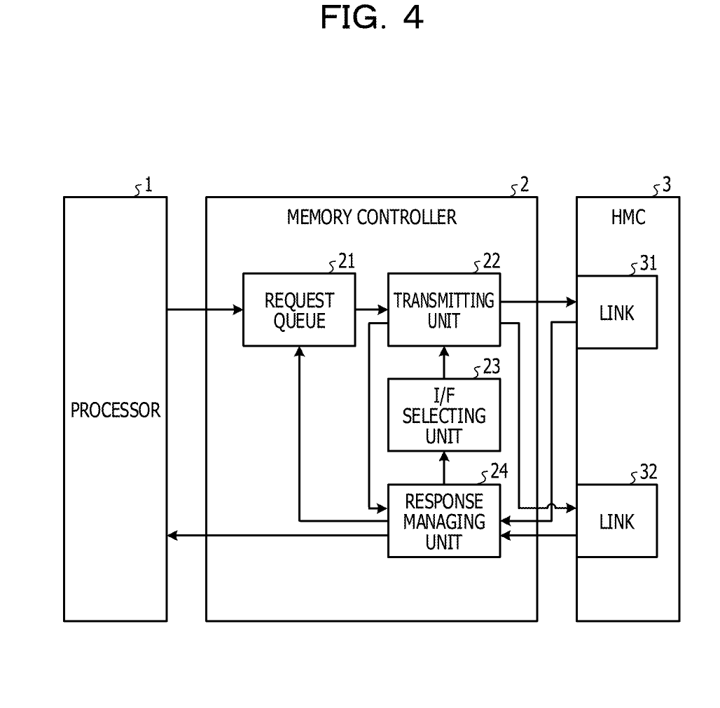

FIG. 4 illustrates an example of an information processor apparatus. The information processor apparatus illustrated in FIG. 4 differs from the information processor apparatus illustrated in FIG. 1 due to the fact that the order of the write requests is guaranteed. Processing for guaranteeing the order of the requests may be mainly explained below. Explanations of configurations and functions substantially the same or similar to the configurations and functions of each element illustrated in FIG. 1 may be omitted below.

When transmitted from the same I/F in FIG. 1, the order for processing the requests to the same address is preserved. For example, if requests are transmitted from different I/Fs, the order of the processing may not be guaranteed. For example, a read request that was issued after a previously issued write request may be processed earlier, and data before an update may be read. If a write request that was issued after a previously issued write request is processed earlier, the data may be updated to the old data. As a result, the order of the subsequently issued requests with regard to previously issued write requests may be guaranteed.

The transmitting unit 22 transmits an identifier of the request corresponding to a write command transmitted by the HMC 3 and the address indicated in the write request to the response managing unit 24.

The response managing unit 24 receives the identifier of the request corresponding to the write command transmitted by the HMC 3 and the address indicated in the write request from the transmitting unit 22.

The response managing unit 24 stores the address indicated by the received write request and the identifier of the request. Next, when the write response is received, the response managing unit 24 erases the identifier of the request corresponding to the write response and the indicated address from the stored information. For example, the response managing unit 24 stores the addresses indicated in write requests for which the commands have been issued and write responses have not been returned.

The request queue 21 obtains the addresses indicated in write requests for which the commands have been issued and write responses have not been returned stored in the response managing unit 24. The request queue 21 removes the write requests and read requests that indicate the address that matches the obtained address, from the objects to be obtained by the transmitting unit 22.

For example, if the response managing unit 24 receives a write response, the address of the write request corresponding to the write response is erased from the information stored by the response managing unit 24. In this case, the request queue 21 returns requests which indicate the same address as the address indicated by the write request to the objects to be obtained by the transmitting unit 22.

The transmitting unit 22 obtains the request at the front of the queue, for example, the stored request with the oldest timing, from the requests except the write requests and the read requests for which commands have been issued and the write responses have not been returned. The transmitting unit 22 carries out the processing to select the I/F for transmitting the command in substantially the same way as or similar way to the information processor apparatus in FIG. 1 and uses the selected I/F to transmit the obtained request to the HMC 3.

As a result, the write request and read request to be issued later that indicate the same address as the previously issued write request may not be processed earlier than the previously issued write request.

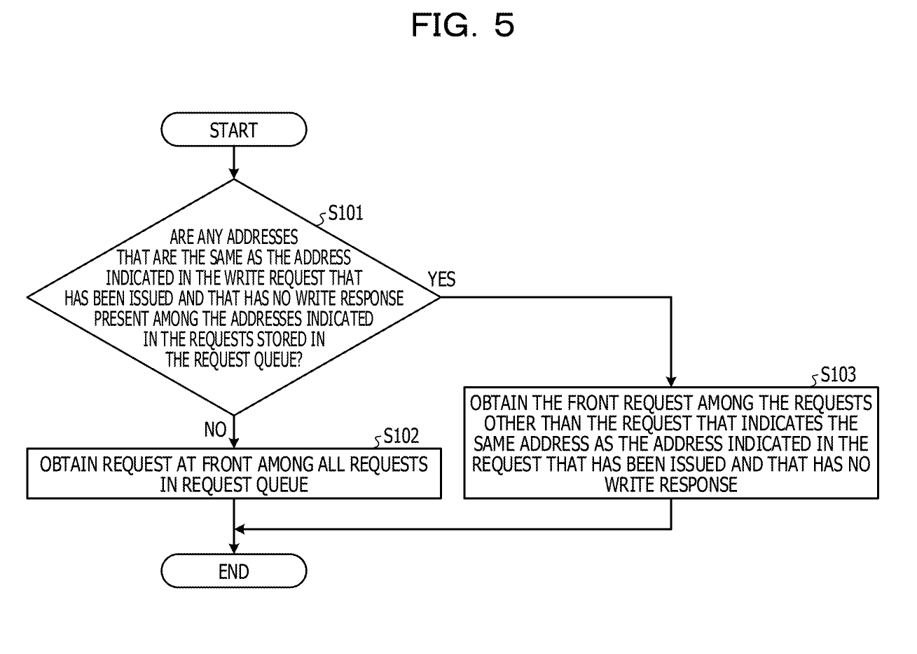

FIG. 5 illustrates an example of guarantee processing for a processing order of requests in an information processor apparatus. The processing illustrated in FIG. 5 may be performed during operation S3 in FIG. 3 for example.

The request queue 21 obtains the addresses indicated in write requests for which the commands have been issued and write responses have not been returned stored in the response managing unit 24. The request queue 21 determines whether any addresses that are the same as the address indicated by the write request that has been issued and that has no write response are present among the addresses indicated in the stored requests (operation S101).

If the same address is not present (operation S101: No), the transmitting unit 22 obtains the request at the front among all the requests in the request queue 21 (operation S102).

If the same address is present (operation S101: Yes), the request queue 21 removes the write requests and the read requests matching the address from the objects to be obtained by the transmitting unit 22. The transmitting unit 22 obtains the front request among the requests other than the request that indicates the same address as the address indicated in the request that has been issued and that has no write response (operation S103).

The order of processing of previously issued requests is guaranteed by the above information processor apparatus. As a result, the reading or writing of data by improper processing may be avoided.

The order of the previously issued write responses may be guaranteed and the order of the previously issued read responses may also be guaranteed. For example, processing that is substantially the same as or similar to the processing for the write request may be performed on a previously issued read request, and the request queue 21 may remove the request that indicates the same address as the address indicated in a request with no read response, from the objects to be obtained by the transmitting unit 22.

As a result, the order for processing the previously issued read responses may also be guaranteed. For example, if the processing for a write request to be issued subsequently is performed before a previously issued read request, a state in which data after updating is read in place of data before updating may be avoided.

The processor 1 and the memory controller 2 may be provided separately. The memory controller 2 may also be mounted, for example, in the processor 1. In this case, the functions of the processor 1 may be executed by a processor core mounted on the processor 1.

The storage device may be a HMC and may be a storage device having a plurality of interfaces with the memory controllers.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processor apparatus comprising:
a storage device configured to perform processing in response to a read request or a write request and output a response after completing the processing;
an arithmetic processor configured to output the read request and the write request to the storage device; and
a control device, including paths coupled to the storage device, configured to control the storage device; wherein,
the control device:
receives the read request or the write request from the arithmetic processor;
acquires, for each of the paths, an overall time until the response to a transmitted read request and a transmitted write request is received based on a first number of the transmitted read requests and a second number of the transmitted write requests, the transmitted read request and the transmitted write request having been transmitted to the paths, responses for the transmitted read request and the transmitted write request having not been received,
selects a used path to be used based on the overall time;
transmits the read request or the write request through the used path to the storage device; and
receives, from the storage device, the response to the read request or the write request through the used path.

2. The information processor apparatus according to claim 1, wherein:
the control device:
adds a first multiplication result in which a second time period for receiving the response to the transmitted write request is multiplied by the second number and a second multiplication result in which a first time period for receiving the response to the transmitted read request is multiplied by the first number; and
calculates the overall time of each of the paths.

3. The information processor apparatus according to claim 1, wherein:
the control device:
selects, when a number of unused paths not having the transmitted read request and the transmitted write request is one, the unused path as the used path from among the output paths is one.

4. The information processor apparatus according to claim 1, wherein:
the control device:
selects the path having the shortest overall time as the used path when the write request is received.

5. The information processor apparatus according to claim 1, wherein:
the control device:
selects the path having the longest overall time as the used path when the read request is received.

6. The information processor apparatus according to claim 1, wherein:
the control device does not transmit, to the storage device, a new write request or a new read request until the processing of the transmitted write request is completed when an address of the storage device indicated in the new write request or the new read request and an address indicated in the transmitted write request are the same.

7. A memory control device comprising:
paths coupled to a storage device; and
a controller configured to supply, through the paths to the storage device, a read request or a write request from an arithmetic processor; wherein,
the controller:
calculates, for each of the paths, an overall time until the response to a transmitted read request and a transmitted write request is received based on a first number of the transmitted read requests and a second number of the transmitted write requests, the transmitted read request and the transmitted write request having been transmitted to the paths, responses for the transmitted read request and the transmitted write request having not been received,
selects a used path to be used based on the overall time:
transmits the read request or the write request through the used path to the storage device and
receives, from the storage device, the response to the read request or the write request through the used path.

8. The memory control device according to claim 7, wherein:
the controller:
adds a first multiplication result in which a second time period for receiving the response to the transmitted write request is multiplied by the second number and a second multiplication result in which a first time period for receiving the response to the transmitted read request is multiplied by the first number to calculate the overall time of each of the paths.

9. The memory control device according to claim 7, wherein:
the controller:
selects, when a number of unused paths not having the transmitted read request and the transmitted write request is one, the unused path as the used path from among the output paths is one.

10. The memory control device according to claim 7, wherein:
the controller:
selects the path having the shortest overall time as the used path when the write request is received.

11. The memory control device according to claim 7, wherein:
the controller:
selects the path having the longest overall time as the used path when the read request is received.

12. The memory control device according to claim 7, wherein:
the controller does not transmit, to the storage device, a new write request or a new read request until the processing of the transmitted write request is completed when an address of the storage device indicated in the new write request or the new read request and an address indicated in the transmitted write request are the same.

13. A control method comprising:
receiving a read request or a write request for a storage device from an arithmetic processor;
calculating, for each of paths, an overall time until the response to a transmitted read request and a transmitted write request is received based on a first number of the transmitted read requests and a second number of the transmitted write requests, the transmitted read request and the transmitted write request having been transmitted to at least one of the paths among the plurality of paths coupled to the storage device, responses for the transmitted read request and the transmitted write request having not been received:
selecting, from the paths, a used path to be used based on the overall time;
transmitting the read request or the write request through the used path to the storage device; and
receiving, from the storage device, the response to the read request or the write request through the used path.

14. The control method according to claim 13, further comprising:
adding a first multiplication result in which a second time period for receiving the response to the transmitted write request is multiplied by the second number and a second multiplication result in which a first time period for receiving the response to the transmitted read request is multiplied by the first number to calculate the overall time of each of the paths.

15. The control method according to claim 13, further comprising:
selecting, when a number of unused paths not having the transmitted read request and the transmitted write request is one, the unused path as the used path from among the output paths is one.

16. The control method according to claim 13, further comprising:
selecting the path having the shortest overall time as the used path when the write request is received.

17. The control method according to claim 13, further comprising:
selecting the path having the longest overall time as the used path when the read request is received.

18. The control method according to claim 13, wherein:
a new write request or a new read request is not transmitted to the storage device until the processing of the transmitted write request is completed when an address of the storage device indicated in the new write request or the new read request and an address indicated in the transmitted write request are the same.
